(19) United States
(12) Patent Application Publication
(10) Pub. No.: US 2011/0098897 A1
(43) Pub. Date: Apr. 28, 2011

(54) Method of identifying a release bearing touch point in a clutch system

(76) Inventor: Matthew Richard Busdiecker, Royal Oak, MI (US)

(21) Appl. No.: 12/589,384

(22) Filed: Oct. 22, 2009

(51) Int. Cl. G06F 19/00

(52) U.S. Cl. 701/67

(57) ABSTRACT

A method for determining a release bearing touch point in a clutch is described. A cross shaft of the clutch is positioned in a pre-determined state. A quantity of torque is applied to the cross shaft using an actuator and a velocity change is determined in the cross shaft. An angular position of the cross shaft is recorded when the velocity change happens as the new release bearing touch point.

### FIELD OF THE INVENTION

The present invention relates to controls for vehicular master clutches, and more particularly to clutch release mechanisms in automatic clutch systems.

### BACKGROUND OF THE DISCLOSURE

In automated vehicular transmission systems utilizing a master friction clutch there commonly exists a mechanical linkage (hereafter called “Clutch Release Hardware”). The Clutch Release Hardware connects an actuation means to the clutch friction interface. The Clutch Release Hardware is designed in such a way that the actuation means is able to modulate the normal force of the clutch friction interface. By modulating the clutch normal force it is possible to control the torque transferred across the clutch interface.

While various arrangements for Clutch Release Hardware are possible, all release hardware has some level of backlash, freeplay, and hysteresis, in the connection between the actuation means and the clutch friction interface. It is also common for these characteristics to change over the life of the clutch due to changes in the clutch friction material thickness and due to wear in the release mechanism.

In addition to the aspects mentioned above, in certain arrangements of the clutch, release bearing, and release fork, the cross shaft can be rotated into a range of positions where the release fork is not in contact with the release bearing. In normal operation the cross shaft is not rotated into this range of positions. However, this non-contacting range of positions may exist as a consequence of the need to design hardware that can be assembled. When the cross shaft is in the non-contacting range of positions, the clutch actuator is not imparting any force to the release bearing. The release fork's engagement with the release bearing initiates at a certain rotation angle of the cross shaft. The cross shaft angle where this contact occurs is called the “Release Bearing Touch Point (RbTp)”.

Using a feedback loop the clutch actuator's position can be controlled. In order for the clutch actuator to be able to modulate the clutch normal force, the clutch actuator must be able to compensate for the effects described above. Finding the Release Bearing Touch Point (“RbTp”), via a calibration procedure, makes it possible for the actuator to determine the range of actuation that is useful in controlling the clutch normal force.

### BRIEF SUMMARY OF THE INVENTION

The present invention relates to clutch systems and more particularly to the control of clutch release mechanisms in automatic vehicular clutch systems. The RbTp represents the rotational angle at which the release fork contacts a release bearing in a clutch system utilizing a powered actuator, e.g., an electric actuator. A rotating cross shaft that passes through a clutch bell housing is used to actuate a release fork. The release fork engages on a release bearing when a torque is applied through the cross shaft. By applying force to the release bearing, the clutch normal force can be controlled, thereby controlling the torque transferred through the clutch.

The clutch actuator does not provide any torque to disengage the clutch when the cross shaft is rotated such that the release fork is not in contact with the release bearing. To rotate the cross shaft so that the clutch actuator disengages the clutch, it is necessary to know the point where the release fork contacts the release bearing, i.e., the RbTp, hence the RbTp needs to be determined.

The RbTp needs to be determined so that the clutch actuator's controller knows the rotation angle required to fully engage the clutch, and also where the disengagement region of the clutch begins. It may also be possible to use the RbTp value, in conjunction with other information, to determine clutch wear or abnormal clutch operation.

In one embodiment, the procedure for determining the RbTp can include the steps of: (1) The actuator is set to a zero torque, (2) The actuator controller waits until the actuator cross shaft velocity is below an RbTpFindVelocity level for an RbTpFindVelocityTime period, and (3) after step (2), the actuator is set to apply a constant torque to the cross shaft. When the cross shaft velocity again falls below the RbTpFindVelocity for a time of RbTpFindVelocityTime, the cross shaft angle is recorded as an RbTp.

Once the initial RbTp is known, the RbTp can be redetermined. In at least one embodiment, the recalculation can be performed by rotating the cross shaft to previously known RbTp, and then carrying out steps similar to the initial determination of the RbTp to find the new RbTp from which a new average RbTp can be determined.

In another embodiment, the RbTp can be recalculated by commanding the actuator to rotate the cross shaft at a predefined velocity while limiting the torque for this purpose to a threshold limit of RbTpFindTorqueLimit.

### BRIEF DESCRIPTION OF THE DRAWINGS

FIG. 1 is a block diagram of a clutch system utilized in an exemplary embodiment of the invention;

FIG. 2 shows cross shaft positions for controlling a clutch in an exemplary embodiment of the invention;

FIG. 3 is a flowchart showing initial determination of release bearing touch point (RbTp) in an exemplary embodiment of the invention;

FIG. 4 is a flowchart showing determination of Release Bearing Touch Point (“RbTp”) when a previous value of the RbTp is known in an exemplary embodiment of the invention; and

FIG. 5 is a flowchart showing determination of the Release Bearing Touch Point (RbTp) using an actuator capable of controlling a cross shaft.

### DETAILED DESCRIPTION OF THE PREFERRED EMBODIMENT

Referring now to the drawings, which are not intended to limit the invention, FIG. 1 is a block diagram of a clutch system 10 utilized in an exemplary embodiment of the invention. An actuation apparatus 12 provides mechanical actuation to a rotational or translational cross shaft (not shown) in the clutch system 10. The actuation apparatus 12 can be an electric motor, pneumatic or hydraulic actuator or any other apparatus that can provide controlled torque or force to a rotational or translational shaft. Those skilled in the art will appreciate that the type of actuation apparatus 12 that can be used will depend on a specific application.

A position sensing mechanism 14 reports the absolute or relative position of the mechanical connection between the actuation apparatus 12 and a clutch release yoke 16. A release bearing 18 is used to control the distance and force between a clutch driven disk (not shown) and a clutch reaction plate (not shown). The release yoke 16 engages on the release bearing 18. There is a range of motion where the release yoke 16 can be out of contact with the release bearing 18.

A control unit 20 transmits a control signal 22 to the actuation apparatus 12. The control unit 20 can perform mathematical and logical operations and can communicate with the actuation apparatus 12 and the position sensing mechanism 14. The control unit 20 calculates a desired torque or force that is communicated to the actuation apparatus 12 via the control signal 22. The control unit signal 22 can be transmitted over a wire or in a wireless manner. Those skilled in the art will appreciate that any other method can be used to transmit the control unit signal 22.

A communication link 24 provides communication between the position sensing mechanism 14 and the control unit 20. The control unit 20 requires position feedback from the mechanical interface to determine how the release yoke 16 is interacting with the release bearing 18.

A mechanical connection 26 provides mechanical linking between the actuation apparatus 12, position sensing mechanism 14 and the release yoke 16. For example, the mechanical connection 26 can be in the form of a translational, rotational or any other physical connection as those skilled in the art will appreciate.

The Release Bearing Touch Point (RbTp) determination is useful for several arrangements of clutch release and actuation hardware. In one arrangement an absolute position sensor measures cross shaft position directly, thereby avoiding any gearset backlash. The “absolute” position sensor refers to a method of sensing that measures the rotation angle of the cross shaft relative to a hardware feature of the assembly. The absolute sensor has an orientation that is set when the sensor is installed. Then the sensor reports the angle between this fixed reference position and the current shaft angle. The absolute sensor does not lose its reference when the controller is reset or powered down. The absolute sensor is generally more expensive than the relative sensor.

In another arrangement of hardware, the cross shaft position is sensed at the driving motor, before the reducing gearset. The need for the controller to know the absolute position of the cross shaft is eliminated. Hence, the calibration procedure makes it possible to use relative position sensing at the motor shaft as the primary position feedback for the actuator. The “relative” position sensor refers to a sensor that does not have a fixed reference position. Typically the relative position sensor uses its initial position at power up as the reference position, so the reference changes for every power on session. This type of sensor is generally used as the feedback for commutation of brushless DC motors.

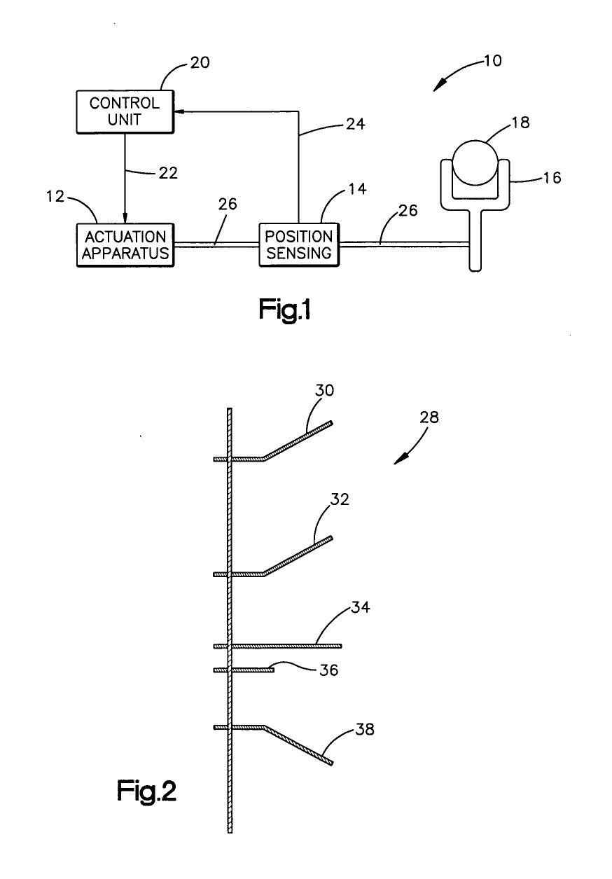

FIG. 2 shows cross shaft positions for controlling a clutch in an exemplary embodiment of the invention. In the clutch system 10 (See FIG. 1), a rotating cross shaft (not shown) is used. The rotating cross shaft passes through the clutch's bell housing, and it is connected to the release yoke 16 (See FIG. 1). The clutch 10 can be engaged or disengaged by releasing or engaging the release bearing 18 (See FIG. 1), which can be moved by removing or applying torque through the cross shaft.

Yoke positions 28 show a set of yoke positions that correspond to a clutch autocalibration procedure. At a pre-clutch engagement stage 30, the yoke 16 contacts the input shafts at a rotational angle of about 150 degrees. A mechanical hard-stop is the state of the clutch 10 at the pre-clutch engagement stage 30. The yoke 16 contacts the release bearing 18 at a fully closed point 32. The clutch 10 is fully engaged at the fully closed point 32. The cross shaft rotates freely between the two states, which are the pre-clutch engagement stage 30 and the fully closed stage 32.

At the fully engaged stage 32, the release bearing 18 contacts the yoke 16 at an angle of about 220 degrees. The angle at which the release bearing 18 contacts the yoke 16 adjusts dynamically over the life of the clutch 10. As a new clutch 10 wears with operation, the point where the release bearing 18 contacts the yoke 16 changes. Hence, determining this Release Bearing Touch Point (“RbTp”) becomes a dynamic process each time the clutch 10 is disengaged.

Once the RbTp has been established, the clutch actuation apparatus 12 (See FIG. 1) can use the RbTp as a reference and other angles can be calculated relative to the RbTp. For example, angles that can be calculated relative to the RbTp can be: (1) an angle for fully disengaging the clutch, (2) an angle for making contact with the clutch brake (not shown), etc. Ability to determine RbTp enables the use of relative position sensing in the actuation apparatus 12's position feedback. Having the position sensor contained in the actuation apparatus may have a cost advantage as it is often necessary to have motor angle feedback if brushless DC motors are used. As the RBTP determination is a dynamic process, the wear in a clutch due to clutch operations does not affect its reliability.

At a torque transfer stage 34, the clutch begins to transfer torque to the transmission (not shown). The contact angle between the yoke 16 and the release bearing is about 245 degrees. This point too moves with clutch wear. At the fully disengaged stage 36, the clutch is fully open, and transfers no torque to the transmission.

At a post engagement stage 38, a mechanical hard-stop is achieved. The clutch is fully disengaged between the torque transfer stage 36 and the post engagement stage 38.

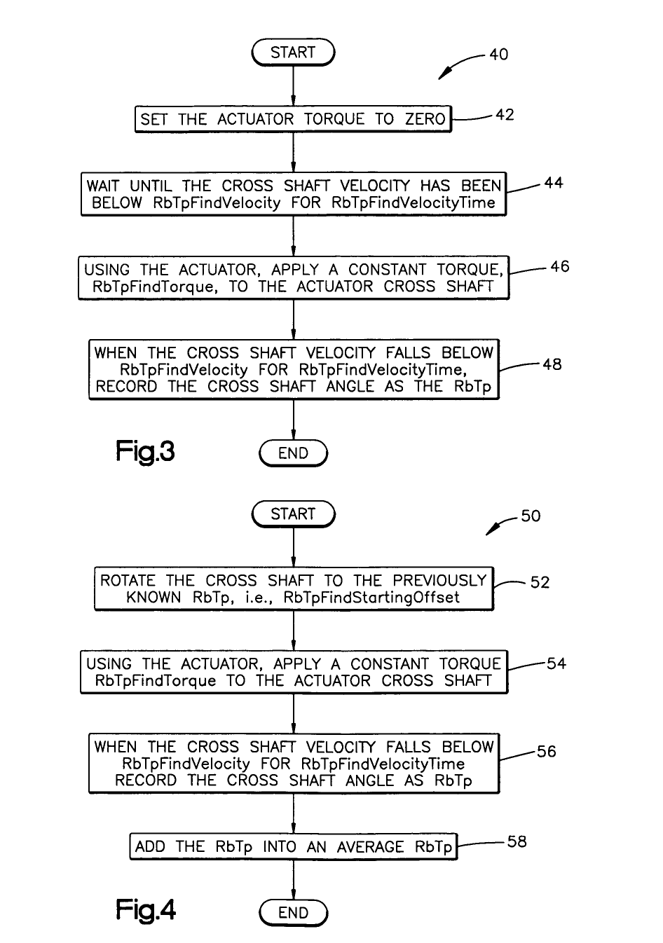

FIG. 3 is a flowchart showing initial determination of a release bearing touch point (RbTp) in an exemplary embodiment of the invention. The flowchart 40 shows the process of calculating the initial value of the release bearing touch point when no prior RbTp value is available. At step 42, the actuation apparatus sets the clutch actuator (not shown) torque to zero. At step 44, the position sensing mechanism 14 waits until the cross shaft velocity remains below a threshold (“RbTpFindVelocity”) for a time span (“RbTpFindVelocityTime”). The RbTpFindVelocity threshold represents an angular velocity below which the cross shaft is considered to be stopped (i.e. no longer rotating). The RbTpFindVelocityTime is the optimal time required to determine the “RbTpFindVelocity” value. Those skilled in the art will appreciate that the RbTpFindVelocity optimal time RbTpFindVelocityTime will vary for different models of clutches.

At a step 46, the actuation apparatus 12 applies a constant torque (“RbTpFindTorque”) to the actuator cross shaft (not shown). The RbTpFindTorque can be chosen such that it follows these criteria: (1) The torque must be sufficient to overcome any friction in the actuator and the release bearing assembly, and (2) The torque must also be chosen to minimize travel into the disengagement region of the clutch. At step 48, the position sensing mechanism 14 waits until the cross shaft velocity falls below the RbTpFindVelocity. At this point, the cross shaft angle is recorded as the RbTp. In this condition the cross shaft angle represents the RbTp because the cross shaft has zero velocity, and force being applied by the actuator (in the direction of disengaging the clutch) is balancing against the force being applied in the engaging direction by the clutch spring, so the release yolk must be in contact with the release bearing.

The RbTp should be determined at least three times during the power-up sequence. The resulting values should be checked for consistency to ensure that the actuator is functioning properly. The RbTp determination procedure should be run once each time the clutch re-engages after being disengaged.

FIG. 4 is a flowchart showing determination of Release Bearing Touch Point (RbTp) when a previous value of RbTp is known in an exemplary embodiment of the invention. Flowchart 50 shows the steps in the process of repeat determination of RbTp. At step 52, the actuation apparatus 12 rotates the cross-shaft (not shown) to a previously known RbTp position (“RbTpFindStartingOffset”). Once the actuator has achieved the “RbTpFindStartingOffset” position, the sequence proceeds to step 54. In step 54 the actuation apparatus 12 applies a constant torque (“RbTpFindTorque”) to the actuator cross shaft. At the step 56, once the cross shaft velocity falls below a threshold (“RbTpFindVelocity”) for the RbTpFindVelocityTime, the cross shaft angle is recorded as RbTp. The newly determined RbTp is added into an average RbTp. Hence, the RbTp value can be determined when a previous value of RbTp is known.

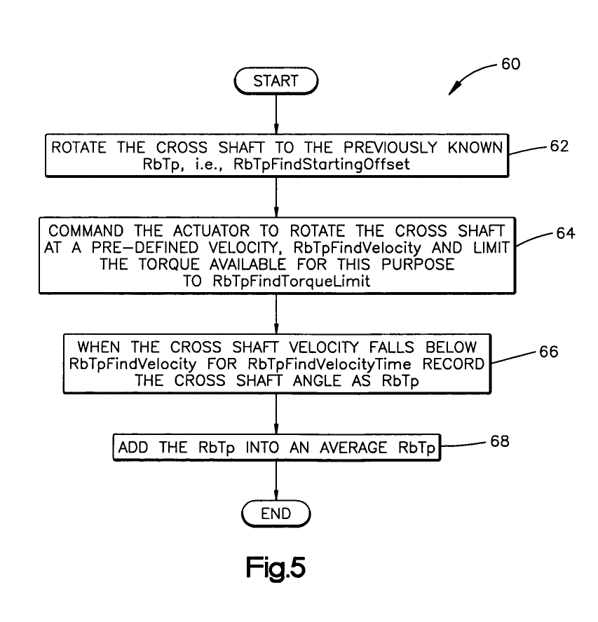

FIG. 5 is a flowchart showing determination of Release Bearing Touch Point (RbTp) using an actuator capable of controlling a cross shaft. In the flowchart 60, the steps illustrate the process of determining RbTp using an actuator that is capable of controlling cross shaft velocity with a torque limit. At step 62, the actuation apparatus 12 rotates the cross-shaft (not shown) to a previously known RbTp position, i.e., RbTpFindStartingOffset. At step 64, once the actuator has achieved the RbTpFindStartingOffset, the control unit 20 commands the actuation apparatus 12 (not shown) to rotate the cross shaft at a pre-defined velocity, RbTpFindVelocity and limits the torque available for this purpose to a limit (“RbTpFindTorqueLimit”). At step 66, when the cross shaft velocity falls below the RbTpFindVelocity threshold for RbTpFindVelocityTime interval, the cross shaft angle is recorded as RbTp. At step 68, the newly determined RbTp is added to an average RbTp.

The invention has been described in detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A method for determining a release bearing touch point in a clutch, the method comprising:
waiting until a cross shaft of the clutch is in a pre-determined state;
applying a torque to the cross shaft using an actuator;
determining a velocity change in the cross shaft; and
recording an angular position of the cross shaft when the velocity change happens.

2. The method of claim 1 wherein the torque applied to the cross shaft is a constant torque.

3. The method of claim 1 wherein the step of determining comprises:
detecting that the cross shaft velocity is below a predetermined velocity threshold.

4. The method of claim 3 further comprising:
establishing that the cross shaft is below the predetermined velocity threshold for a predetermined time interval.

5. The method of claim 1 wherein the angular position of the cross shaft being recorded corresponds to the release bearing touch point.

6. The method of claim 1 further comprising:
confirming that the release bearing touch point is being determined for the first time.

7. The method of claim 1 wherein the predetermined state corresponds to a zero position of the actuator.

8. A method for determining a release bearing touch point in a clutch, the method comprising:
rotating a cross shaft of the clutch to a position that corresponds to a previously known position of the release bearing touch point;
applying a torque to the cross shaft using an actuator;
determining a velocity change in the cross shaft; and
recording an angular position of the cross shaft when the velocity change happens.

9. The method of claim 8 wherein the torque applied to the cross shaft is a constant torque.

10. The method of claim 8 wherein the step of determining comprises:
detecting that the cross shaft velocity is below a predetermined velocity threshold.

11. The method of claim 10 further comprising:
establishing that the cross shaft is below the predetermined velocity threshold for a predetermined time interval.

12. The method of claim 8 wherein the angular position of the cross shaft being recorded corresponds to a new release bearing touch point.

13. The method of claim 12 further comprising:
using the new release bearing touch point to calculate an average of the release bearing touch point.

14. A method for determining a release bearing touch point in a clutch, the method comprising:
rotating a cross shaft of the clutch to a position that corresponds to a previously known position of the release bearing touch point;
turning the cross shaft using an actuator at a predetermined velocity while limiting a torque applied for the turning to a predetermined torque limit;
determining a velocity change in the cross shaft; and
recording an angular position of the cross shaft when the velocity change happens.

15. The method of claim 14 wherein the step of determining comprises:
detecting that the cross shaft velocity is below a predetermined velocity threshold.

16. The method of claim 15 further comprising:
establishing that the cross shaft is below the predetermined velocity threshold for a predetermined time interval.

17. The method of claim 14 wherein the angular position of the cross shaft being recorded corresponds to a new release bearing touch point.

18. The method of claim 17 further comprising:
Using the new release bearing touch point to calculate an average of the release bearing touch point.
